(19) United States
(12) Patent Application Publication
(10) Pub. No.: US 2024/0137278 A1
(43) Pub. Date: Apr. 25, 2024

(54) CLOUD MIGRATION DATA ANALYSIS METHOD USING SYSTEM PROCESS INFORMATION, AND SYSTEM THEREOF

(71) Applicant: Open Source Consulting Inc., Seoul (KR)

(72) Inventor: Ji Woong Choi, Yongin-si (KR)

(21) Appl. No.: 18/278,833

(22) PCT Filed: Dec. 27, 2021
(86) PCT No.: PCT/KR2021/019926

§ 371 Date: Aug. 23, 2023

(30) Foreign Application Priority Data
Feb. 24, 2021 (KR) 10-2021-0024516

(51) Int. Cl. H04L 41/12; H04L 43/04; H04L 43/065

(52) U.S. Cl. CPC H04L 41/12; H04L 43/04; H04L 43/065

(57) ABSTRACT

Disclosed is a method for analyzing cloud migration data using system process information including an inventory storage operation of identifying servers running at a first time point in a data center including a plurality of servers, analyzing information on operating systems of the identified servers, and storing the operating system information in an inventory, a process information collection operation of collecting process information of the servers stored in the inventory, an inverse tracking operation of retrieving process state information of software using each process based on a result of analyzing the collected process information, a correlation information identification operation of identifying correlation information between a server, a connection target server connected to the server via a network, and software running on the server, based on the retrieved process state information, and a correlation information output operation of outputting the identified correlation information.

### BACKGROUND OF THE INVENTION

The present disclosure relates to a method for analyzing multiple servers running in a data center, and more specifically, to a method for analyzing and managing a data center to increase efficiency prior to migrating multiple servers included in the data center and operating into a cloud environment.

A data center refers to a building or a facility that provides server computers and network lines. As a more extended concept than the past, the data center is also defined as a facility that collects various data connected to the Internet. The data center is composed of a router that is a communication device, a plurality of servers, and an uninterruptible power supply system (UPS) for controlling power to be stably supplied to each module constituting the data center. The data center is characterized by being established when it is necessary to geographically centralize storage to efficiently process various information collected via the Internet.

Although the data center is essential enough to be required by all companies of a magnitude equal to or greater than a certain magnitude, to build the data center physically intact, it is necessary to secure a stable space and to be equipped with various equipment supporting the data center in advance. Therefore, a recent trend is changing from a scheme in which the company secures a physical space to build and operate the data center directly to a scheme of building and using a virtual data center via a cloud service provider.

The virtualization of the data center has advantages of consuming less equipment, power, and space compared to the traditional physical data center, as well as accessing a public or private cloud or bursting when more storage or processing resources are needed. Because services such as networking and storage provided by the cloud-based virtual data center are provided via software rather than hardware, the virtual data center may be referred to as a software-defined data center.

In one example, the various servers running in multiple server operating environments in the data center where various operating systems coexist have a large number of software installed to operate business applications. To manage the applications installed on the server, an enterprise asset management systems (EAMS) solution, an inventory management system, and the like have been introduced. However, in reality, there is a problem in that there is a gap between collected system information and actual system information because there is no way to divide management areas for a server administrator, a network administrator, an application administrator, and a database administrator and automatically collect system analysis information on a task-based basis.

In addition, according to a current management scheme, because of the nature of one server being shared by multiple administrators for work, the system is not updated for changes such as installing additional software on or adding business applications to the system. Therefore, when converting the physical data center into the cloud system-based virtual data center, a situation in which a lot of resources are additionally added to identify and analyze the changes inevitably occurs. That is, in migrating from the physical data center to the virtual data center, there is a problem of requiring a lot of extra cost and time in addition to a basic migration cost, and there is no plan to solve such problem at present.

Specifically, as an existing Unix environment is converted to an x86 environment, complexity of the system increases and a system analysis task becomes more difficult because of a change of the person in charge. Even when the migration is performed using an inventory solution, a process of mapping software information with business system information must be handled separately.

In the past, there was a technology for simply increasing efficiency of the migration of the data center. For example, Prior Art Document 1 (Patent No. 10-1634409) to be described later proposes a method for identifying locations of the resources across the data centers to increase the migration efficiency, and Prior Art Document 2 (Patent No. 10-1675818) suggests a parameterized dynamic model for the cloud migration.

However, the methodologies disclosed in the above-mentioned prior art documents are merely technologies related to the migration between the physical data centers, or are limited to simply analyzing a correlation between communication interfaces of the server systems by analyzing environments of system process information and port information during the cloud migration. Specifically, previously known technologies use a scheme of utilizing connection port information of a source server and a target server generated from the system port information to extract information on a system interface for communication from one server to another server, exhibiting information between systems, and separately managing the servers.

Another analysis method, a migration method via existing log analysis, simply tracks a called client IP or a call target IP as a result of post-processing, not a system process currently in use, and thus, also has limitations in expressing the interface correlation.

In addition, a method for building a data repository to store service procedures, documents, sources, configurations, topologies, applications, and the like necessary for IT service operation via a separate configuration management DB (CMDB) and use them efficiently is known. However, such method also has a problem that the person in charge must actively upload and manage the corresponding contents, and a problem of not being updated because changes in the system are not able to be reflected in real time.

As a result, the previously known method and the analysis system for implementing the method do not accurately reflect the systemic situation change that occurs over time in a state in which no preceding procedure for accurately analyzing the correlation between processes of the multiple servers has been performed in advance. Therefore, in the case of converting to the cloud environment after analyzing the actual system, it is inevitable to analyze the entire system again, which inevitably results in cost and time wastage resulted from double analysis.

### SUMMARY OF THE INVENTION

The present disclosure is to provide a method for managing and analyzing a data center such that problems that occur when migrating a physical data center system composed of multiple servers to a cloud environment may be identified in advance, and a system for implementing the method.

A first aspect of the present disclosure provides a method for analyzing cloud migration data using system process information, the method comprising: an inventory storage operation of identifying servers running at a first time point in a data center including a plurality of servers, analyzing information on operating systems of the identified servers, and storing the operating system information in an inventory; a process information collection operation of collecting process information of the servers stored in the inventory; an inverse tracking operation of retrieving process state information of software using each process based on a result of analyzing the collected process information; a correlation information identification operation of identifying correlation information between a server, a connection target server connected to the server via a network, and software running on the server, based on the retrieved process state information; and a correlation information output operation of outputting the identified correlation information.

A second aspect of the present disclosure provides a system for analyzing cloud migration data using system process information, the system comprising: an inventory storage processor that identifies servers running at a first time point in a data center including a plurality of servers, analyzes information on operating systems of the identified servers, and stores the operating system information in an inventory; a process information collector that collects process information of the servers stored in the inventory; an inverse tracker that retrieves process state information of software using each process based on a result of analyzing the collected process information; a correlation information identifier that identifies correlation information between a server, a connection target server connected to the server via a network, and software running on the server, based on the retrieved process state information; and a correlation information outputter that outputs the identified correlation information.

A third aspect of the present disclosure provides a computer-readable recording medium storing a program for executing the method.

According to the present disclosure, the costs incurred for migrating the multiple servers in the data center to the cloud environment may be drastically reduced.

In addition, according to the present disclosure, the errors that occur when migrating the servers into the various public/private cloud environments may be minimized and the migration speed may be improved.

### BRIEF DESCRIPTION OF THE DRAWINGS

The accompanying drawings illustrate the invention. In such drawings:

FIG. 1 is a diagram schematically showing an entire system implementing the present disclosure;

FIG. 2 is a diagram schematically showing a block diagram of an example of a data analysis system;

FIG. 3 is a diagram schematically showing a block diagram of another example of a data analysis system;

FIG. 4 is a flowchart for illustrating a server inventory tracking algorithm processed by a server analysis module in FIG. 3;

FIG. 5 is a diagram for illustrating a process in which a server analysis module extracts a network interface target server;

FIG. 6 is a diagram for illustrating a scheme in which a server analysis module obtains process information using a PID extracted from a network;

FIG. 7 is a diagram schematically illustrating a relationship between information extractable by a server analysis module from an analysis target server;

FIG. 8 is a flowchart showing an example of a solution inverse tracking method via an operating system command;

FIG. 9 schematically shows information that may be obtained by tracking setting contents with a web server process;

FIG. 10 schematically shows information that may be obtained by tracking setting contents with a web application server process;

FIG. 11 is a diagram for illustrating a method for obtaining network interface information by analyzing a WAS configuration file;

FIG. 12 is a flowchart for illustrating a technique of analyzing a program (software) operated in a web application server;

FIG. 13 is a flowchart showing an application analysis process when an application is an Enterprise JAVA Beans (an EJB Java standard);

FIG. 14 schematically shows a flowchart according to a service analysis embodiment;

FIG. 15 schematically shows an example of a correlation structure between servers in a data center; and

FIG. 16 is a flowchart showing an example of a cloud migration data analysis method using process information according to the present disclosure.

### DETAILED DESCRIPTION OF THE PREFERRED EMBODIMENTS

A first aspect of the present disclosure provides a method for analyzing cloud migration data using system process information, the method comprising: an inventory storage operation of identifying servers running at a first time point in a data center including a plurality of servers, analyzing information on operating systems of the identified servers, and storing the operating system information in an inventory; a process information collection operation of collecting process information of the servers stored in the inventory; an inverse tracking operation of retrieving process state information of software using each process based on a result of analyzing the collected process information; a correlation information identification operation of identifying correlation information between a server, a connection target server connected to the server via a network, and software running on the server, based on the retrieved process state information; and a correlation information output operation of outputting the identified correlation information.

In one embodiment of the method, the process information collection operation includes further collecting IP information and port information of the servers stored in the inventory, and the inverse tracking operation includes retrieving the process state information based on a result of analyzing the collected process information, IP information, and port information.

In one embodiment of the method, the inventory storage operation includes identifying information on sockets opened by the operating systems, and the process information collection operation includes identifying information of ports opened by the operating systems used in the servers via the identified socket information.

In one embodiment of the method, the inverse tracking operation includes identifying, based on the identified port information, a list of programs used in currently running servers and information of a connection target server connected to the servers.

In one embodiment of the method, the inverse tracking operation includes identifying a process ID of a program running a daemon, and determining which type among a web server, a web application server (WAS), and a database (DB) the servers stored in the inventory belong to based on the identified process ID.

In one embodiment of the method, the inverse tracking operation includes identifying target software lowering efficiency of migration based on the result of analyzing the collected process information.

In one embodiment of the method, the inverse tracking operation includes retrieving a JAVA runtime version, class information, and a library required for operation when the collected process information is information of JAVA.

In one embodiment of the method, the inverse tracking operation includes additionally detecting another server in addition to the servers identified at the first time point when the collected process information is information of one of SSH, FTP, and Telnet.

In one embodiment of the method, the method further includes an application conversion operation of specifying an application lowering efficiency of cloud migration via application triggering and sequentially performing packaging and repackaging of the specified application.

In one embodiment of the method, the correlation information output operation includes building, visualizing, and outputting a topology based on information composed of the servers identified at the first time point.

In one embodiment of the method, the correlation information output operation includes processing and outputting the identified correlation information into a document viewable only by a user with a level equal to or higher than a predetermined level.

A second aspect of the present disclosure provides a system for analyzing cloud migration data using system process information, the system comprising: an inventory storage processor that identifies servers running at a first time point in a data center including a plurality of servers, analyzes information on operating systems of the identified servers, and stores the operating system information in an inventory; a process information collector that collects process information of the servers stored in the inventory; an inverse tracker that retrieves process state information of software using each process based on a result of analyzing the collected process information; a correlation information identifier that identifies correlation information between a server, a connection target server connected to the server via a network, and software running on the server, based on the retrieved process state information; and a correlation information outputter that outputs the identified correlation information.

A third aspect of the present disclosure provides a computer-readable recording medium storing a program for executing the method.

Terms used in the embodiments have been selected from general terms that are currently widely used as much as possible while considering functions in the present disclosure, but the terms may change depending on an intention of a technician working in the related field, a precedent, or an emergence of a new technology. In addition, in a specific case, there is also a term arbitrarily selected by the applicant, and in this case, a meaning thereof will be described in detail in the description. Therefore, the term used in the present disclosure should be defined based on a meaning thereof and contents across the present disclosure, not merely a name thereof.

When it is described that a certain part ‘includes’ a certain component throughout the present document, it means that other components may be further included without excluding other components unless otherwise stated. In addition, terms such as “ . . . unit” and “ . . . module” described herein mean a unit that processes at least one function or operation, which may be implemented as hardware or software or a combination of the hardware and the software.

Hereinafter, with reference to the accompanying drawings, the embodiment of the present disclosure will be described in detail such that a person having ordinary knowledge in the technical field to which the present disclosure belongs may easily implement the same. However, the present disclosure may be implemented in many different forms and may not be limited to the embodiments described herein.

Hereinafter, embodiments of the present disclosure will be described in detail with reference to drawings.

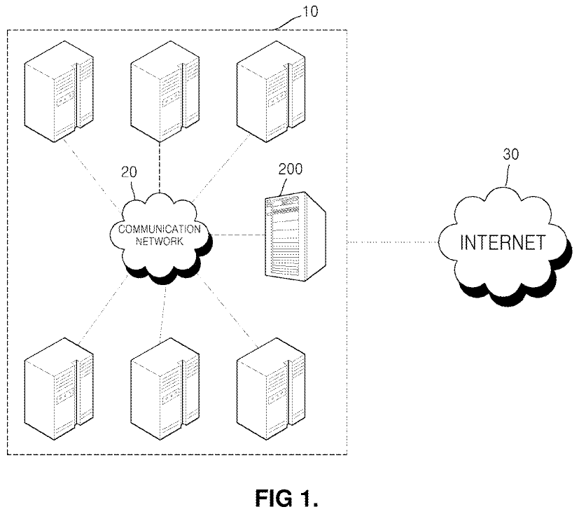

FIG. 1 is a diagram schematically showing an entire system implementing the present disclosure.

Referring to FIG. 1, it may be seen that the entire system implementing the present disclosure includes a data center 10, a data center communication network 20, a cloud migration data analysis system 200 according to the present disclosure, and the Internet 30. Hereinafter, for convenience of description, the cloud migration data analysis system 200 according to the present disclosure will be abbreviated as the data analysis system 200.

First, the data center 10 may be implemented in a form in which a plurality of servers are connected to each other via the data center communication network 20. In this regard, the data center 10 means a data center of a traditional concept that physically occupies a certain portion of a space used by a company that operates the corresponding data center 10, and an appearance of the data center 10 before migrating to a cloud environment is shown.

The data center communication network 20 may perform a function of connecting the server constituting the data center 10 to various network support modules, and may be implemented as the Internet as well as an intranet and a virtual private network (VPN) according to an embodiment. Although omitted in FIG. 1, it will be obvious to those skilled in the art that the entire system in FIG. 1 includes a general component such as a router that allows multiple servers to access the Internet 30 using one IP assigned by an internet service provider (ISP) and a firewall that monitors and selectively blocks packets.

The data analysis system 200 is connected to the data center communication network 20, selectively identifies running servers among the servers included in the data center 10, and collects and analyzes process information, thereby performing a function of diagnosing problems that may occur when an entirety or a portion of the data center 10 is migrated to the cloud environment in advance. The data analysis system 200 may use the data center communication network 20 to collect the process information of the servers included in the data center 10 or inversely track state information of processes of software running on the servers. Each server constituting the data center 10 does not need to have an agent program installed in advance to perform such function.

The data analysis system 200 may analyze a correlation between the plurality of servers and information including third party solutions, such as WEB/WAS/DB solutions, security information required for program operation, and library information necessary for the program operation, and provide the correlation to a user, thereby significantly improving efficiency of the migration.

The data analysis system 200 described in the present disclosure performs the analysis for improving the efficiency of the cloud migration based on the process information output in real time from the running server.

In a case of a scheme of analyzing and utilizing log of the servers, which is one of previously known schemes, the log is merely trailing data, so that, unless log of an application is changed at a development level, there was a limitation in that a correlation between interfaces of the servers is not able to be tracked.

On the other hand, when the interface is identified and analyzed via the process information of the server as in the present disclosure, a process using a specific daemon, a program using a specific port, and a communication direction of source/destination IPs, which may be obtained therefrom, may be collectively identified, so that network visualization may be more effectively triggered.

The Internet 30 is a communication network for connecting the servers included in the data center 10 to an external system. The data center 10 may access a cloud provided by a cloud service provider via the Internet 30, and virtualization of the data center 10 may be processed via the Internet 30. Operation of the data center 10 whose virtualization has been completed may also be performed via the Internet 30.

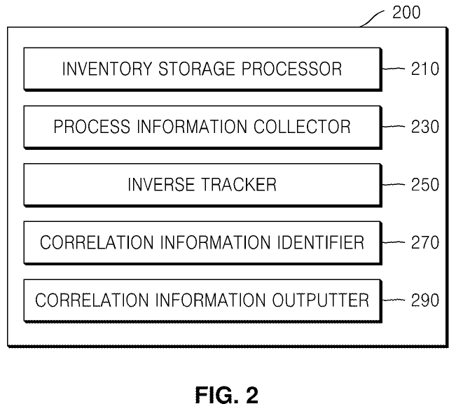

FIG. 2 is a diagram schematically showing a block diagram of an example of a data analysis system.

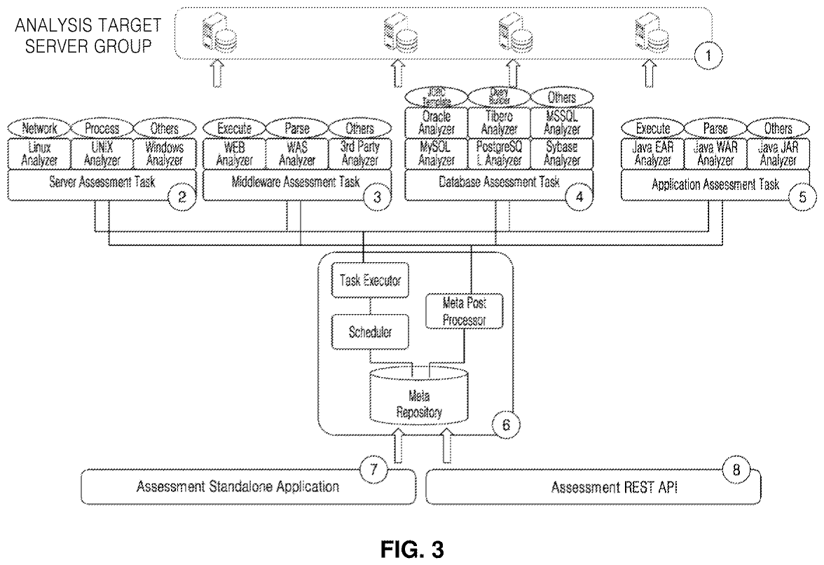

Referring to FIG. 2, it may be seen that the data analysis system 200 according to the present disclosure includes an inventory storage processor 210, a process information collector 230, an inverse tracker 250, a correlation information identifier 270, and a correlation information outputter 290. The data analysis system 200 in FIG. 2 simply and intuitively shows the functions of the data analysis system 200 described in FIG. 1, and is able to include various modules to be described in FIG. 3 as sub-modules. A specific function of each component included in the data analysis system 200 will be described later with reference to FIGS. 3 to 14.

In addition, the inventory storage processor 210, the process information collector 230, the inverse tracker 250, the correlation information identifier 270, and the correlation information outputter 290 included in the data analysis system 200 may correspond to at least one processor or include the at least one processor. Accordingly, the data analysis system 200 may be operated in a form included in another hardware device such as a microprocessor or a general-purpose computer system.

Each component included in the data analysis system 200 is named so as to most intuitively express a function of the corresponding component. It will be apparent to those skilled in the art that the component may be called differently unlike as shown in FIG. 2 when actually implemented and operated.

The number of modules included in the data analysis system 200 is not limited to that shown in FIG. 2. That is, the number of modules included in the data analysis system 200 may be 5 as shown in FIG. 2, greater than 5, or smaller than 5. For example, the inventory storage processor 210, the process information collector 230, the inverse tracker 250, the correlation information identifier 270, and the correlation information outputter 290 may be implemented as one integrated chipset using a system on chip (SoC). In this case, although these are logically 5 modules, the 5 modules may be classified as one module integrated on hardware.

The inventory storage processor 210 identifies servers running at a first time point in the data center 10 including the plurality of servers, analyzes operating system (OS) information of the identified servers, and stores the information in an inventory. In this regard, the first time point indicates a time point specified to specify only servers that are actually running and thus trackable via the data center communication network 20 among the servers included in the data center 10. Because the data analysis system 200 according to the present disclosure collects and analyzes the process information of the servers at regular intervals, there may be infinitely many time points over time such as a second time point, a third time point, and the like.

The process information collector 230 collects the process information of the servers stored in the inventory.

As an embodiment, the inventory storage processor 210 may identify information on sockets opened by the operating systems of the servers, and the process information collector 230 may identify information on ports opened in the operating systems by utilizing the identified socket information. The inverse tracker 250, which will be described later, may identify a list of programs being used in the server and a connection target system connected to the corresponding server by utilizing the port information identified by the process information collector 230.

The inverse tracker 250 retrieves process state information of software using each process based on the result of analyzing the collected process information.

As one embodiment, the process information collector 230 may further collect IP information and the port information of the servers stored in the inventory in addition to the above-described process information, and the inverse tracker 250 may retrieve the process state information of the software based on a result of analyzing the collected process information, IP information, and port information.

As another embodiment, the inverse tracker 250 may identify a process ID of a program operating the daemon, and determine which types among a web server, a web application server (WAS), and a database (DB) the servers stored in the inventory belong to based on the identified process ID.

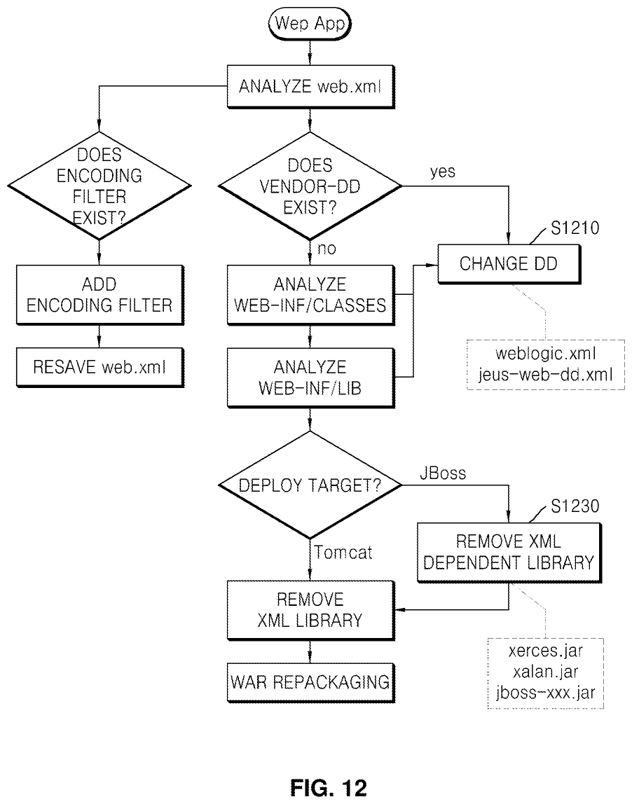

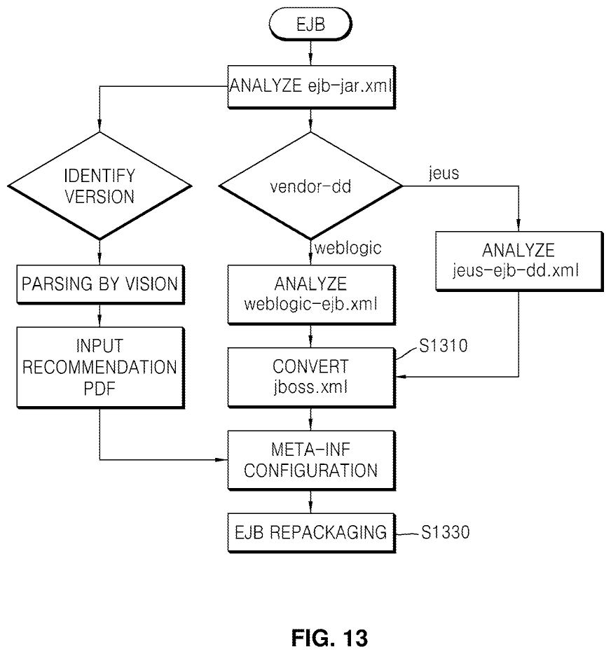

In addition, the inverse tracker 250 may determine target software that lowers the migration efficiency based on the result of analyzing the collected process information. The software that affects the migration efficiency may be converted based on a preset rule after a package is released and then repackaged, which will be described later with reference to FIGS. 12 and 13.

When the collected process information is JAVA, the inverse tracker 250 may retrieve a JAVA runtime version, class information, and a library (a DLL extension file) required for operation. In addition, when the collected process information is one of SSH, FTP, and Telnet, the inverse tracker 250 may additionally detect other servers in addition to the servers identified at the first time point.

The correlation information identifier 270 identifies information on a correlation between a server, a connection target server connected to the server via the data center communication network 20, and software running on the server, based on the process state information retrieved by the inverse tracker 250.

The correlation information outputter 290 outputs the correlation information identified by the correlation information identifier 270. As an example, the correlation information outputter 290 may process the correlation information identified by the correlation information identifier 270 into a document that may be viewed only by a user of a level equal to or higher than a predetermined level and output the document. As another example, the correlation information outputter 290 may construct a topology based on information composed of the servers identified at the first time point and output visualized information to a terminal of the user. The user may detect problems caused by the migration in advance by identifying the document or the topology.

FIG. 3 is a diagram schematically showing a block diagram of another example of a data analysis system.

FIG. 3 is a diagram showing the data analysis system 200 described in FIG. 2 in detail. Each block shown in FIG. 3 means a module that may operate individually, and it has already been described that each module may be implemented in the form included in each component included in the data analysis system 200. Hereinafter, a description will be made with reference to FIG. 2.

First, an analysis target server group 1 at an upper end in FIG. 3 means the plurality of servers included in the data center 10. In FIG. 3, the number of servers included in the analysis target server group 1 is 4, but this is for convenience of description. Therefore, it is obvious that the number of servers included in the analysis target server group may be greater than 4 according to an embodiment.

Next, a server analysis module 2 is a module that identifies the servers included in the analysis target server group 1 and performs analysis based on a type of process each server has. The server analysis module 2 may be implemented in a form included in the inventory storage processor 210 that identifies the running servers among the servers included in the data center 10 and analyzes and stores the operating system information of the identified servers.

The server analysis module 2 accesses the data center communication network 20 connected to the data center 10, then identifies the running servers among the servers included in the analysis target server group 1, then analyzes the system information of the operating systems (OS) of the corresponding servers, and then stores the analyzed information in the inventory. In this regard, the inventory, as a record of the servers to be managed and analyzed by the server analysis module 2, may be updated as time elapses after the first time point.

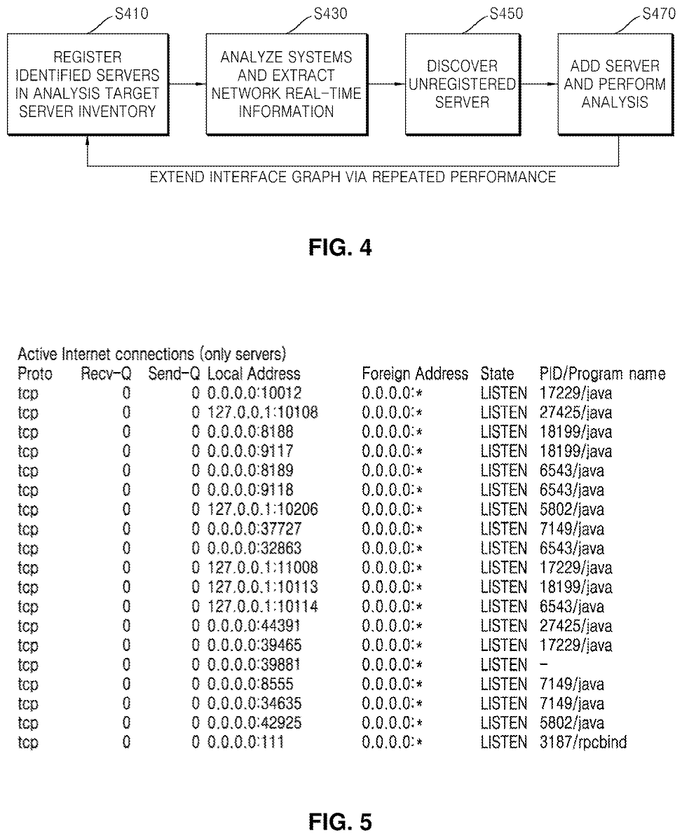

FIG. 4 is a flowchart for illustrating a server inventory tracking algorithm processed by a server analysis module in FIG. 3.

First, the server analysis module 2 selectively identifies only the servers that are running (online) in the analysis target server group 1, and registers the identified servers in an analysis target server inventory (S410).

Subsequently, the server analysis module 2 collects the process information of the servers registered in the inventory, analyzes the systems of the servers, and extracts network real-time information (S430).

The server analysis module 2 may discover an unregistered server (S450), and register the discovered unregistered server in the inventory and perform analysis thereon (S470). Operations S410 to S470 may be repeated at regular intervals.

As shown in FIG. 3, the server analysis module 2 includes a Unix analyzer, a Linux analyzer, and a Windows analyzer as sub-modules because the module goes through the process of first identifying the system information of the operating system of each server to analyze the systems of the identified servers.

In addition, the server analysis module 2 is implemented in a form included in the process information collector 230 that collects the process information of the servers stored in the inventory. In other words, the server analysis module 2 identifies the information of the port currently opened in the operating system by utilizing the information on the socket opened by the operating system, and identifies the list of the programs currently being used on the server and the connection target server (a connection target system) connected to the corresponding server by utilizing the port information.

FIG. 5 is a diagram for illustrating a process in which a server analysis module extracts a network interface target server.

The server analysis module 2 identifies the open port information from information shown in FIG. 5, and identifies the list of the programs in use and the connection target system by utilizing the port information. The server analysis module 2 may identify the process ID of the program operating the daemon using the corresponding port only for information whose state is LISTEN, and identify which type among the web server, the WAS, and the DB the corresponding server corresponds to via the process ID.

As described above, according to the present disclosure, even when the separate agent program is not installed on each server constituting the data center and each server is not labeled in advance, which type among the web server, the WAS, and the DB the server corresponds to may be identified via the process ID.

Subsequently, the server analysis module 2 may collect the process information by utilizing a process ID (PID) list extracted from the network, and may identify migration target software that is being operated via the collected process information.

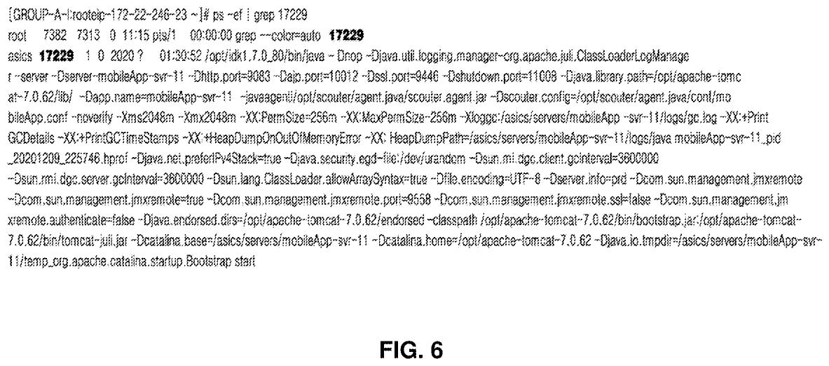

FIG. 6 is a diagram for illustrating a scheme in which a server analysis module obtains process information using a PID extracted from a network.

More specifically, FIG. 6 schematically shows a result of obtaining process information on a JAVA Runtime via matching of a process ID indicated as 17229.

When the identification of the process is completed via a port used, the server analysis module 2 retrieves process state information of software that uses such process, and performs an inverse tracking task for the corresponding software. For example, when the process running on the server turns out to be JAVA, a daemon that utilizes the web application server (WAS) identifies the JAVA runtime version required to operate the same, the class information required to run the software, and the list of library files (DLLs) required. Therefore, the server analysis module 2 inversely tracks the corresponding software by utilizing the identified JAVA runtime version, class information, and list of libraries as the process state information.

As another example, when the process identified by the server analysis module 2 is the process such as the SSH, the FTP, the Telnet, and the like that uses the network among the system processes used by the operating system, whether a client has accessed the target server is also identified in the above-described method, whether the server is the server included in the inventory recorded in advance is identified, the server is registered in the inventory when it is the unregistered server, and the corresponding work routine is repeated. The inventory registration and analysis processes of the unregistered server have already been described in FIG. 4, so that a description thereof will be omitted.

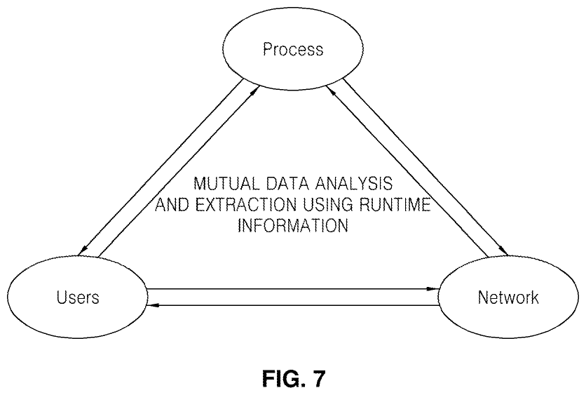

As described above, the server analysis module 2 may be implemented in a form included in each of the inventory storage processor 210, the process information collector 230, and the inverse tracker 250 described in FIG. 2. Via the analysis of the user/process/network state information by the data analysis system 200, the information being used by the software becomes the information (the process state information) extracted by the server analysis module 2 via the inverse tracking, and a relationship between the user of the analysis target server, the process running on the corresponding server, and the network state information of the corresponding server is as shown in FIG. 7.

FIG. 7 is a diagram schematically illustrating a relationship between information extractable by a server analysis module from an analysis target server.

As shown in FIG. 7, because the user, process, and network state information are intertwined in the process state information that may be extracted (retrieved) by the server analysis module, remaining related information may be identified as soon as information on any one of those is identified.

As a specific example, a process of identifying a DB correlation is performed in a work system via an open source web server. For example, the server analysis module 2 may identify a location of the server where the web server is running via the web server process, and may automatically find a directory where a configuration file exists at the corresponding location. The server analysis module 2 may identify a number of the port used by the target server, certificate information, a document root, a library in use (an active DLL), a log location, and the like via the configuration file of the web server. In addition, the server analysis module 2 may identify information on the WAS of a backend from the configuration file.

The process of identifying the information in reverse via the correlation between the information shown in FIG. 7 may be referred to as triggering of the information. Hereinafter, the triggering performed when the server included in the analysis target server group 1 is identified as one of the web server, the WAS, and the DB will be described in detail. An advantage of the information collection via the triggering is that, as described in FIG. 7, the correlation between the user/process/network/server, which are the components of the operating system, may be effectively identified, and accordingly, a portion that lowers the migration efficiency may be accurately determined.

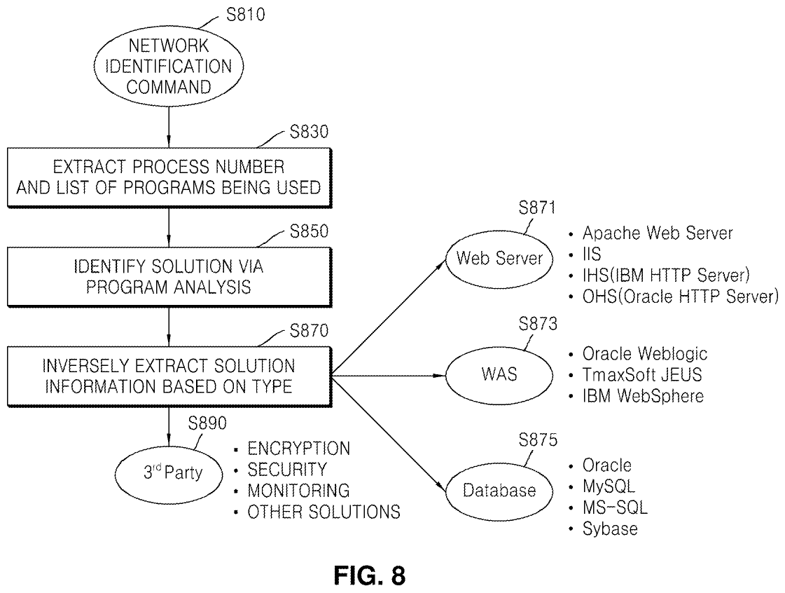

FIG. 8 is a flowchart showing an example of a solution inverse tracking method via an operating system command.

When there is a network identification command (S810), the server analysis module 2 extracts the process number (the process ID) and the list of programs being used in the target server (S830).

The server analysis module 2 identifies a solution via the program analysis (S850), and inversely identifies and extracts solution information based on the type of server (S870).

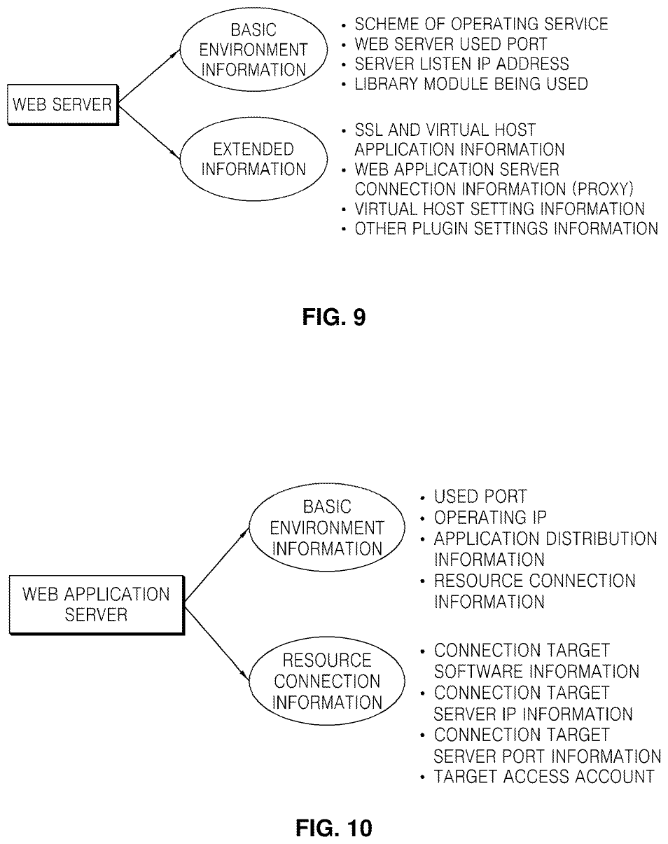

In operation S870, when the server is turned out to be one of an Apache web server, an Internet information server (IIS), an IBM HTTP server (IHS), and an oracle web server (OHSweb server), the operation branches to operation S871 and the web server triggering proceeds in the same process as shown in FIG. 9.

FIG. 9 schematically shows information that may be obtained by tracking setting contents with a web server process.

The web servers may be classified into various types of solutions. The server analysis module 2 extracts environment setting information corresponding to the process of each solution from the process running on the operating system.

For example, when the Apache web server analyzes the process while running in real time, the server analysis module 2 identifies whether RPM-based installation is made or whether user compile is performed, and a location of a configuration file that operates the corresponding process is able to be tracked in reverse. FIG. 9 shows that the server analysis module 2 is able to know the basic environment setting information and extended information of the target server functioning as the web server via the web server triggering, as described above.

As another example, in operation S870, when the server is turned out to be one of an Oracle WebLogic, a TmaxSoft JEUS, and an IBM Websphere, the operation may branch to operation S873, and WAS information triggering may proceed in the same process as shown in FIG. 10.

FIG. 10 schematically shows information that may be obtained by tracking setting contents with a web application server process.

In operation S873, the server analysis module 2 recognizes that information of the backend WAS recorded in the web server is operated in the same server or in another server. Using the identified information, the server analysis module 2 may identify a JAVA process operated with a specific port on the corresponding server, and identify, via a specific string expressed as a state message of such JAVA process, an operating JAVA version of the corresponding web application software, the location of the configuration file, the socket information, and language information. Because there are various WAS manufacturers, the server analysis module 2 may include a policy for extracting analysis information via a parsing repository having configuration files for each manufacturer.

Referring to FIG. 10, it may be seen that the server analysis module 2 identifies the basic environment setting information (the used port, an operating IP, and application distribution information) and resource connection information (connection target software information, connection target server IP information, connection target server port information, and target connection account information) of the server turned out to be the WAS via the web application server triggering.

The web application servers store all the basic information for running the server in a form of XML files. When the server analysis module 2 analyzes a main XML file required for operating the process, a number of port that is operated by the server, a class library used, a server name, information required for database connection, a name of a distributed application, a directory location, and various tuning information may be identified. In this regard, the identified information may be expressed as individual components when the data analysis system 200 visualizes and outputs the correlation information.

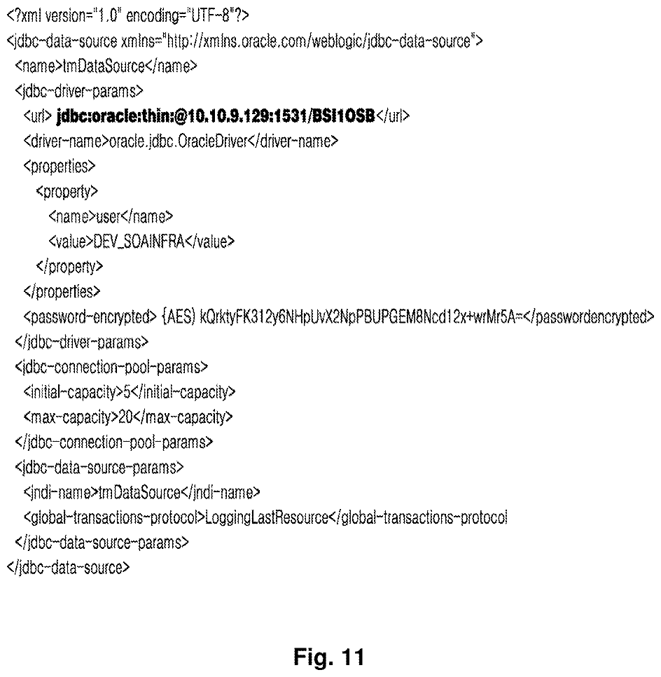

FIG. 11 is a diagram for illustrating a method for obtaining network interface information by analyzing a WAS configuration file.

A file shown in FIG. 11 represents the WAS configuration file detected by the server analysis module 2 and is written in the XML format. The server analysis module 2 may obtain and utilize highlighted information (URL information) in a fifth line in FIG. 11 as the network interface information.

As another example, operation S870 may branch to operation S875. Database information triggering (DB information triggering) refers to a procedure in which, when the server analysis module 2 identifies connection information registered in the web application server and an administrator of the target server is registered, information is obtained after analysis of data, such as a data usage, a table space, archive information, and the number of data for each table, is performed.

Finally, the server analysis module 2 may perform application information triggering. When the WAS is analyzed based on the information obtained via the process information, the server analysis module 2 may inversely track information on a location where the application is distributed by utilizing the information of the analyzed WAS. The JAVA application whose location is identified has different packaging methods (JAR, WAR, EAR, and the like) depending on a type thereof and has a unique standardized structure. The server analysis module 2 may extract the number of screens, a business logic processing file, an environment configuration file, and the like via file analysis in a sub-directory. In this process, the application is analyzed, converted, and migrated in a form shown in FIG. 12 or 13. When the analysis target server is the WAS, an analysis procedure utilizing a vendor-specific attribute of a software manufacturer and a directory standard analysis procedure may be performed in parallel.

FIG. 12 is a flowchart for illustrating a technique of analyzing a program (software) operated in a web application server.

As shown in FIG. 12, the program operated in the WAS goes through a DD change procedure in operation S1210 or is processed via an XML dependent library removal procedure in operation S1230 and then repackaged, thereby eliminating problems occurring in the migration in advance.

In the above process, the sub-directory of the directory of the analyzed application must be configured on a standard basis to operate without errors even after the repackaging, so that the server analysis module 2 may perform file encoding analysis, distribution descriptor analysis, library correlation analysis, and dependent content analysis, specific property file analysis, and the like of the corresponding directory to identify the problems that may occur during the migration in advance, and control a document with the corresponding problems written to be created later.

FIG. 13 is a flowchart showing an application analysis process when an application is an Enterprise JAVA Beans (an EJB Java standard).

Referring to FIG. 13, similar to FIG. 12, it may be seen that the server analysis module 2 selectively performs jeus-ejb-dd.xml analysis, executes jboss.xml conversion processing (S1310), and performs EJB repackaging, thereby completing the analysis on the application (S1330). As the application is analyzed as shown in FIG. 13, the problems that occur when migrating the data center 10 to the cloud environment may be identified in advance, and the migration efficiency may be improved via the conversion processing in operation S1310.

Hereinafter, the description of FIG. 3 will be continued.

A middleware analysis module 3 identifies whether the analysis target server is a server of a specific solution vendor currently sold in the industry only for a case in which an inverse tracking target is analyzed to be middleware via the process analysis of the server analysis module 2, and, using the identification result, performs the function of analyzing the XML-based setting information of each server by inversely tracking the server setting information of each server based on the directory. According to an embodiment, the middleware analysis module 3 may operate physically or logically dependent on the server analysis module 2, and accordingly, may be implemented in a form included in the inverse tracker 250 in FIG. 2.

A database analysis module 4 performs a function of analyzing the database information tracked by the process analyzed by the server analysis module 2 and the middleware analysis module 3. The database analysis module 4 may track a user of the database, meta-information of the database, a capacity of the database, a procedure of the database, and the like, and may additionally identify information such as a data file, a control file, a segment, a DB link, and the like. The database analysis module 4 may also be physically or logically included in the server analysis module 2 and operate according to the embodiment, and may be implemented in a form included in the inverse tracker 250 in FIG. 2.

An application analysis module 5 may be implemented in a scheme physically or logically included in the server analysis module 2 while being involved in the aforementioned application triggering.

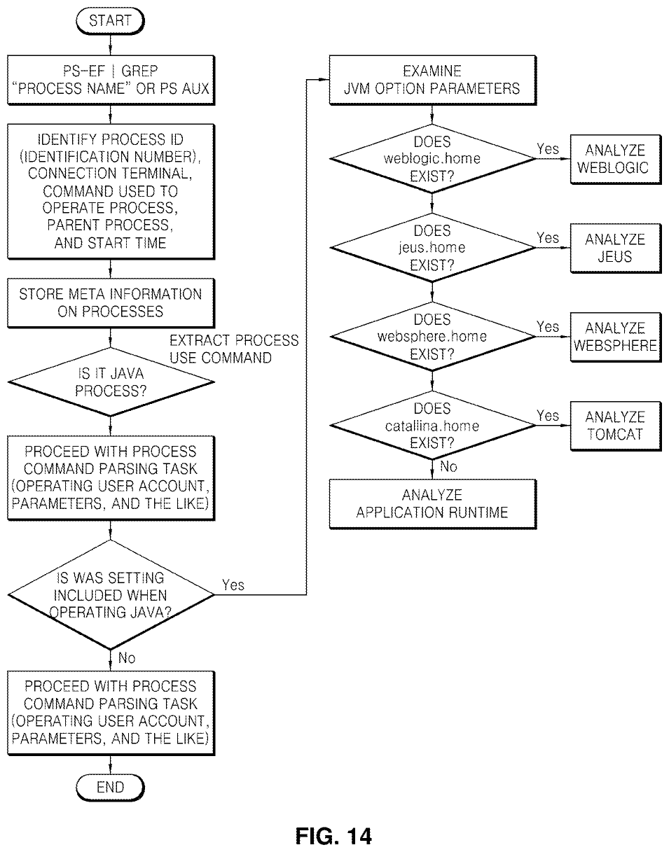

FIG. 14 schematically shows a flowchart according to a service analysis embodiment.

More specifically, FIG. 14 briefly shows functions performed by the server analysis module 2, the middleware analysis module 3, the database analysis module 4, and the application analysis module 5 in FIG. 3 in one flowchart.

FIG. 14 schematically illustrates that the distributed application is able to be tracked via configuration analysis when the middleware is tracked in reverse, and when the data analysis system 200 according to the present disclosure uses the Java, there is a module that performs a function of identifying the problems that occur during the migration in advance via used framework information, an external system interface in a property, an IP, port information, and used query analysis.

When a Java program runs as a class file rather than a source, the analysis modules included in the data analysis system 200 track the IP and the port in a binary file using a ByteCode Instrument (BCI) technology, which is an important tool to identify an interface correlation between the servers.

A management module 6 performs a function of storing the information collected from the above-described various analysis modules and executing periodic tasks to continuously collect and manage updated information of the analysis target server group 1. The management module 6 includes a task executor, a scheduler, a meta post processor, and a meta repository as sub-modules to process the above tasks.

The management module 6 performs a function of constructing and processing meta data to map the process information and the process state information collected via the inverse tracking by the process and network information into correlation data and output the correlation data as visualized information. The function performed by the management module 6 is one of the most important characteristics of the present disclosure, and is a function of setting the meta information such that the aforementioned operating system analysis information, web server analysis information, web application server analysis information, and database information are able to be expressed as a correlation graph between the systems.

In the present disclosure, after being first analyzed at the first time point, the analysis target server group 1 constituting the data center 10 may change in the state by the servers additionally installed by the administrator or started operating after the first time point. That is, because the servers recorded in the inventory at the first time point must be updated and reanalyzed at a time point (the second time point, the third time point, and the like) after the first time point to enable update of the system, the management module 6 may maintain latest state information with a scheme of updating the correlation information between the servers at a regular interval via the scheduler. The management module 6 may be implemented in a form physically or logically included in the correlation information identifier 270 in FIG. 2.

Subsequently, an application result module 7 performs a function of processing the correlation information calculated by the management module 6 into a result of a format such as an Excel or word document, and a Rest API module 8 performs a function of visualizing the document output by the application result module 7 and transmitting the visualized document to a screen of the user's terminal. The application result module 7 and the Rest API module 8 may be implemented in a form physically or logically included in the correlation information outputter 290 in FIG. 2.

The management module 6 accumulates the metadata by utilizing information connected between the various types of servers included in the analysis target server group 1, and the application result module 7 includes a graph library for calculating an interface relationship diagram between the systems based on the data received from the management module 6.

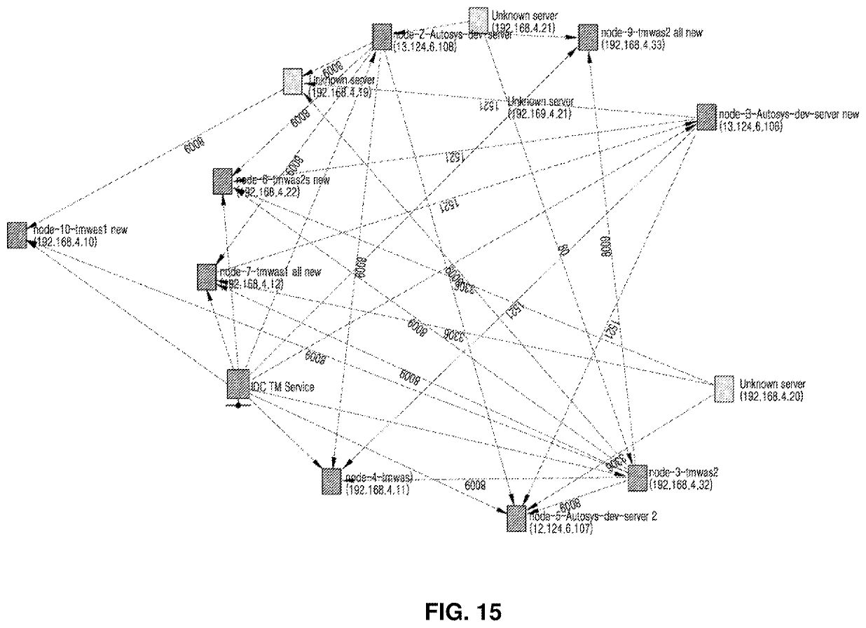

An authorized user who has access to the data center 10 may intuitively understand a data flow in the data center 10 by identifying the correlation structure diagram between the servers as shown in FIG. 15. Correlation analysis results and application conversion/repackaging procedures carried out in such process may significantly reduce the problems that occur when migrating the data center 10 to the cloud environment, saving the time and the cost.

FIG. 15 schematically shows an example of a correlation structure between servers in a data center.

The user may identify, via the user terminal, the update of the topology whenever the topology of the correlation between the servers as shown in FIG. 15 is updated. With reference to FIG. 15, the user may identify that three unknown servers have been added via the update.

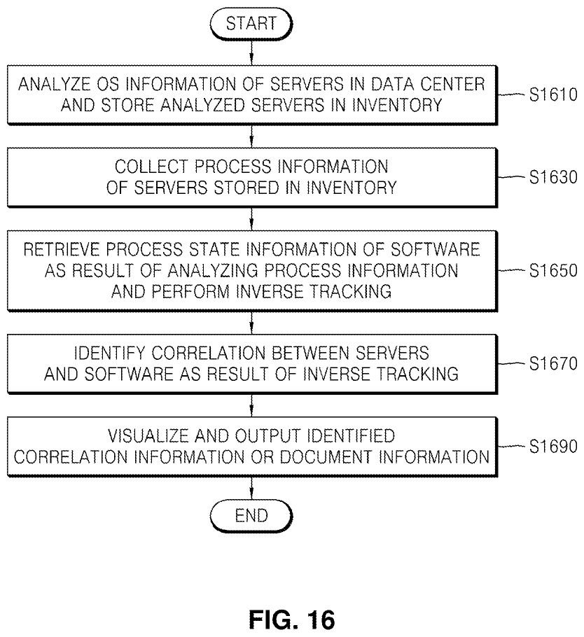

FIG. 16 is a flowchart showing an example of a cloud migration data analysis method using process information according to the present disclosure.

Because the method shown in FIG. 16 may be implemented with reference to FIG. 2 or 3, a description will be made hereinafter with reference to FIG. 2, and descriptions duplicated with the contents described in FIGS. 2 and 3 will be omitted.

The inventory storage processor 210 analyzes the OS information of the servers included in the data center and stores the analyzed servers in the inventory (S1610).

The process information collector 230 collects the process information of the servers stored in the inventory (S1630).

The inverse tracker 250 retrieves the process state information of the software as a result of analyzing the process information and performs the inverse tracking (S1650).

The correlation information identifier 270 identifies the correlation between the servers and the software as a result of the inverse tracking (S1670).

The correlation information outputter 290 visualizes and outputs the identified correlation information or documents the information (S1690).

It has already been described that operations S1610 to S1690 may be performed by the sub-module in FIG. 3 included in each module in FIG. 2 in addition to the above-described hardware subject that performs the operations.

According to the task and interface inverse tracking method via the system process of the present disclosure, the cost of analysis and migration of the plurality of servers managed by the data center may be minimized, and inventory management for a large number of servers may become available via the information analyzed in real time. When migrating to the cloud environment, the transfer of the business system and the reflection of the changes become faster because of the information that is analyzed in advance and continuously updated, so that tasks that were previously redundantly analyzed and managed by humans may be systematized to minimize mistakes, and accurate management tasks may be performed.

In addition, reliability of the migration target server, the process, and the software may be increased by performing analysis of the currently running process rather than an existing log level analysis.

In addition, as the administrator of the data center visually and effectively identifies the interfaces between the business services, the migration efficiency may be significantly increased.

Embodiments according to the present disclosure described above may be implemented in a form of a computer program that may be executed on a computer via various components, and such a computer program may be recorded on a computer-readable medium. In this regard, the medium may include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory.

In one example, the computer program may be specially designed and configured for the present disclosure, or may be known to and usable by those skilled in the art of computer software. An example of the computer program may include not only machine language codes generated by a compiler but also high-level language codes that may be executed by the computer using an interpreter or the like.

Specific implementations described in the present disclosure are merely embodiments, and do not limit the scope of the present disclosure in any way. For brevity of the present document, descriptions of conventional electronic components, control systems, software, and other functional aspects of the systems may be omitted. In addition, the connection of the lines or connecting members between the components shown in the drawings exemplarily represent functional connections and/or physical or circuit connections, and are able to be represented as various functional, physical, or circuit connections that may be replaced or added in actual devices. In addition, when there is no specific mention such as “essential”, “important”, and the like, a component may not be a necessary component for the application of the present disclosure.

In the present document (particularly in the claims) of the present disclosure, the use of the term “above-mentioned” and similar indicating terms may be applied to both singular and plural cases. In addition, in the present disclosure, when a range is described, it includes an invention to which individual values belonging to the above range are applied (unless there is contradiction thereto), and it is the same as describing each individual value constituting the above range in the detailed description of the present disclosure. Finally, the operations of the method according to the present disclosure may be performed in an appropriate order, unless the order for the operations is clearly described or there is a contradicted description. The present disclosure is not necessarily limited to the described order of the above operations. The use of all examples or exemplary terms (for example, and the like) is for a purpose of describing the present disclosure in detail. The scope of the present disclosure is not limited by the above examples or exemplary terms unless limited by the claims. In addition, those skilled in the art may appreciate that various modifications, combinations, and changes may be made based on design conditions and factors within the scope of the appended claims or equivalents thereof.

One embodiment of the present disclosure may be used in a migration service industry provided to businesses migrating from a physical database system to a cloud database system.

What is claimed is:

1. A method for analyzing cloud migration data using system process information, the method comprising:
an inventory storage operation of identifying servers running at a first time point in a data center including a plurality of servers, analyzing information on operating systems of the identified servers, and storing the operating system information in an inventory;
a process information collection operation of collecting process information of the servers stored in the inventory;
an inverse tracking operation of retrieving process state information of software using each process based on a result of analyzing the collected process information;
a correlation information identification operation of identifying correlation information between a server, a connection target server connected to the server via a network, and software running on the server, based on the retrieved process state information; and
a correlation information output operation of outputting the identified correlation information.

2. The method of claim 1, wherein the process information collection operation includes further collecting IP information and port information of the servers stored in the inventory,
wherein the inverse tracking operation includes retrieving the process state information based on a result of analyzing the collected process information, IP information, and port information.

3. The method of claim 1, wherein the inventory storage operation includes identifying information on sockets opened by the operating systems,
wherein the process information collection operation includes identifying information of ports opened by the operating systems used in the servers via the identified socket information.

4. The method of claim 3, wherein the inverse tracking operation includes identifying, based on the identified port information, a list of programs used in currently running servers and information of a connection target server connected to the servers.

5. The method of claim 4, wherein the inverse tracking operation includes identifying a process ID of a program running a daemon, and determining which type among a web server, a web application server (WAS), and a database (DB) the servers stored in the inventory belong to based on the identified process ID.

6. The method of claim 1, wherein the inverse tracking operation includes identifying target software lowering efficiency of migration based on the result of analyzing the collected process information.

7. The method of claim 1, wherein the inverse tracking operation includes retrieving a JAVA runtime version, class information, and a library required for operation when the collected process information is information of JAVA.

8. The method of claim 1, wherein the inverse tracking operation includes additionally detecting another server in addition to the servers identified at the first time point when the collected process information is information of one of SSH, FTP, and Telnet.

9. The method of claim 1, further comprising:
an application conversion operation of specifying an application lowering efficiency of cloud migration via application triggering and sequentially performing packaging and repackaging of the specified application.

10. The method of claim 1, wherein the correlation information output operation includes building, visualizing, and outputting a topology based on information composed of the servers identified at the first time point.

11. The method of claim 1, wherein the correlation information output operation includes processing and outputting the identified correlation information into a document viewable only by a user with a level equal to or higher than a predetermined level.

12. The method of claim 1, including a computer-readable recording medium storing a program for executing the method according to claim 1.

13. A system for analyzing cloud migration data using system process information, the system comprising:
an inventory storage processor configured to identify servers running at a first time point in a data center including a plurality of servers, analyze information on operating systems of the identified servers, and store the operating system information in an inventory;
a process information collector configured to collect process information of the servers stored in the inventory;
an inverse tracker configured to retrieve process state information of software using each process based on a result of analyzing the collected process information;
a correlation information identifier configured to identify correlation information between a server, a connection target server connected to the server via a network, and software running on the server, based on the retrieved process state information; and
a correlation information outputter configured to output the identified correlation information.
